(19) United States
(12) Patent Application Publication
(10) Pub. No.: US 2010/0266786 A1
(43) Pub. Date: Oct. 21, 2010

(54) LIGHTGUIDE PLATE, METHOD OF MANUFACTURING LIGHT GUIDE PLATE, AND BACKLIGHT UNIT WITH THE LIGHT GUIDE PLATE

(75) Inventors: Takashi Shimura, Fujiyoshida-shi (JP); Daisaku Okuwaki, Fujiyoshida-shi (JP)

Correspondence Address: BRINKS HOFER GILSON & LIONE, P.O. BOX 10395, CHICAGO, IL, 60610, US

(73) Assignee: CITIZEN ELECTRONICS CO. LTD., Fujiyoshida-shi (JP)

(21) Appl. No.: 12/827,937

(22) Filed: Jun. 30, 2010

Related U.S. Application Data
(62) Division of application No. 11/843,542, filed on Aug. 22, 2007.

(30) Foreign Application Priority Data
Aug. 22, 2006 (JP) JP2006-225762

(51) Int. Cl. B05D 5/06

(52) U.S. Cl. 427/595

(57) ABSTRACT

An edge-light type light guide plate (30) is provided that has a first surface (31) and a second surface (32) that are opposed to each other, and a peripheral edge surface extending between the peripheral edges of the first and second surfaces. A part of the peripheral edge surface is defined as a light entrance plane (30a). The first surface (31) has a series of parallel elongated raised surfaces (31a) of arcuate cross-section that extend in a direction substantially normal to the light entrance plane (30a). The second surface (32) has a series of parallel elongated recessed surfaces (32a) of triangular cross-section that extend in a direction substantially normal to the elongated raised surfaces (31a) on the first surface.

This application is a Divisional application that claims priority to U.S. Ser. No. 11/843,542, filed on Aug. 22, 2007, which claims priority under 35 U.S.C. §119 to Japanese Patent Application No. JP2006-225762 filed Aug. 22, 2006, the entire contents of both are hereby incorporated by reference.

### TECHNICAL FIELD

The present invention relates to backlight units for use in display devices such as liquid crystal display devices. More particularly, the present invention relates to a light guide plate used in an edge-light type lighting device and also relates to a backlight unit using the same.

### RELATED PRIOR ART

Liquid crystal display devices have been widely used in personal computers, liquid crystal display televisions, electronic organizers, mobile phones, and other terminal display devices. A backlight unit is provided at the lower side of a liquid crystal display panel of such a liquid crystal display device to make the displayed image appear bright and sharp. The backlight unit often uses an edge-light type light guide plate with a view to achieving a thin backlight unit structure. In the edge-light type light guide plate, a light source is provided adjacent to a side edge surface of the light guide plate so that light from the light source enters the light guide plate through the side edge surface and is guided toward the inner part of the light guide plate, thereby allowing the light to be emitted from the entire area of the upper surface of the light guide plate.

Japanese Patent Application Publication No. 2004-6193 discloses a liquid crystal display device having a backlight unit as shown in FIG. 21. In this liquid crystal display device, a backlight unit (lighting device) 8 housed in a casing 9 is provided at the lower side of a liquid crystal panel 1.

The backlight unit 8 has a light guide plate 6. Three LEDs (light-emitting diodes) 3 mounted on a substrate 7 are provided close to a side edge surface 6c of the light guide plate 6 in such a way that light-emitting surfaces 3a of the LEDs 3 face the side edge surface 6c. A diffuser sheet 26 is provided directly above a first surface (upper surface) 6a of the light guide plate 6 that serves as a light exit surface. Two prism sheets 25 and 24 are stacked on the diffuser sheet 26, and another diffuser sheet 23 is stacked on the prism sheet 24. A reflective sheet 27 is provided directly below a second surface (lower surface) 6b of the light guide plate 6. A heat sink 5 is connected to the substrate 7 to dissipate heat generated from the LEDs 3. An adhesive sheet 28 with partly light reflecting and blocking effect is bonded to the lower surface of the peripheral edge of the liquid crystal panel 1 to effectively utilize illuminating light from the backlight unit 8.

Light emitted from the light-emitting surfaces 3a of the LEDs 3 enters the light guide plate 6 through the side edge surface 6c and travels through the light guide plate 6. While doing so, the light properly exits the upper surface 6a of the light guide plate 6 under the action of the reflective sheet 27. The exiting light passes through the diffuser sheet 26, the two stacked prism sheets 25 and 24, and further through the diffuser sheet 23 to illuminate the liquid crystal panel 1 with uniformly distributed light. The heat sink 5 keeps the whole liquid crystal display device at a uniform temperature to minimize unevenness of display brightness on the liquid crystal panel 1.

Light guide plates are generally formed by injection molding using resin materials excellent in heat resistance, moisture resistance, light-deterioration resistance, impact resistance, chemical resistance, etc. such as acrylic resins and polycarbonate resins. Injection molding process enables mass-production of light guide plates superior in accuracy.

Injection molding process, however, requires the light guide plate thickness to be greater than a certain value in order to allow the resin material to be appropriately filled in the molding tool. For example, many light guide plates for use in mobile phones and the like are formed with a thickness in the range of from 0.5 to 1.0 mm. The thickness of light guide plates can be somewhat reduced if they are injection-molded by using a large-sized injection molding machine with high injection pressure. Even in such a case, the light guide plate thickness needs to be greater than a certain value. The use of a large-sized injection molding machine increases installation cost. Furthermore, manufacture of light guide plates of different thicknesses needs a plurality of injection molds to be prepared therefor, resulting in an increase in mold cost.

### SUMMARY OF THE INVENTION

An object of the present invention is to solve the above-described problems with the conventional light guide plates.

The present invention provides an edge-light type light guide plate having a first surface and a second surface opposite to the first surface, and a peripheral edge surface extending between the peripheral edges of the first and second surfaces. A part of the peripheral edge surface is defined as a light entrance plane. The first surface has a series of parallel elongated raised surfaces of arcuate cross-section that extend in a direction substantially normal to the light entrance plane. The second surface has a series of parallel elongated recessed surfaces of triangular cross-section that extend in a direction substantially normal to the raised surfaces on the first surface.

In this edge-light type light guide plate, light entering the light guide plate through the light entrance plane is guided toward the inner part thereof by the action of the raised surfaces. The amount of light emitted from the surface (light exit surface) provided with the raised surfaces can be appropriately controlled by properly adjusting the angles and so forth of inclined surfaces defining the recessed surfaces according to the distance of the inclined surfaces from the light entrance plane. Accordingly, the amount of light emitted from the light exit surface can be adjusted to be uniform over the entire area thereof, and hence the luminance can be made uniform over the entire light exit surface. In addition, the degree of diffusion of emitted light can be controlled by varying the curvature of the raised surfaces. In addition, both the raised and recessed surfaces are simple in configuration and hence easy to form. That is, the raised and recessed surfaces can be formed by press forming. Thus, the light guide plate can be reduced in thickness.

Specifically, the arrangement may be as follows. Each of the elongated recessed surfaces is defined by first and second inclined surfaces where the first inclined surface is closer to said light entrance plane than the second inclined surface, and inclination angles of the first inclined surfaces of the elongated recessed surfaces gradually increase with the recessed surfaces being situated farther away from the light entrance plane. The depths of the elongated recessed surfaces may gradually increase with the recessed surfaces being situated farther away from the light entrance plane. The pitches of the elongated recessed surfaces may gradually decrease with the recessed surfaces being situated farther away from the light entrance plane.

With the above-described arrangement, even if the amount of light guided toward the inner part of the light guide plate decreases with distance from the light entrance plane, light can be efficiently emitted from the light exit surface of the light guide plate, and luminance unevenness on the light exit surface can be minimized.

The edge-light type light guide plate may be made of a synthetic resin sheet. In this case, the raised and recessed surfaces may be press-formed. Thus, the thickness of the light guide plate can be reduced considerably in comparison to the conventional light guide plates.

Specifically, the raised and recessed surfaces may be formed by application of hot pressing.

In another specific example, the edge-light type light guide plate may have a resin sheet and UV (ultraviolet) curing resin coating layers provided on both sides of the resin sheet to define the first and second surfaces, and the raised and recessed surfaces may be press-formed on the UV curing resin coating layers.

In addition, the present invention provides a light guide plate assemblage having a multiplicity of the above-described edge-light type light guide plates that are integrally formed adjacent to each other. In other words, a large-sized light guide plate capable of producing a multiplicity of edge-light type light guide plates is prepared, and this is cut into a plurality of desired edge-light type light guide plates.

In addition, the present invention provides a light guide plate manufacturing method including the steps of: preparing a synthetic resin sheet having a first surface and a second surface that are opposite to each other; preparing a first forming die having a series of parallel elongated recessed forming surfaces of arcuate cross-section; preparing a second forming die having a series of parallel elongated raised forming surfaces of triangular cross-section; pressing the recessed-shaped surfaces of the first forming die against the first surface to form on the first surface a series of parallel elongated raised surfaces of arcuate cross-section; and pressing the raised-shaped surfaces of the second forming die against the second surface such that said raised surfaces are oriented at right angles to the parallel elongated raised surfaces on the first surface to form on the second surface a series of parallel elongated recessed surfaces of triangular cross-section.

In short, this method manufactures light guide plates by press forming. Accordingly, the method requires a shorter time for forming than the conventional method using injection molding and enables the thickness of the light guide plate to be reduced to a considerable extent.

Specifically, the first and second forming dies may be heated and pressed against the first and second surfaces, respectively.

More specifically, the first and second forming dies may be pressed against the synthetic resin sheet from both sides thereof to simultaneously form the raised surfaces on the first surface and the recessed surfaces on the second surface.

In another specific example, the first and second forming dies may be in the shape of a roller and press against the synthetic resin sheet from both opposite sides thereof while rotating to form the series of parallel elongated raised and recessed surfaces.

In another specific example, the light guide plate manufacturing method may be as follows. The step of preparing the synthetic resin sheet includes the steps of: feeding a resin sheet; forming a first UV curing resin coating layer defining the first surface on one side of the resin sheet; and forming a second UV curing resin coating layer defining the second surface on the other side of the resin sheet. The step of forming the series of parallel elongated raised surfaces includes the step of forming the series of parallel elongated raised surfaces on the first UV curing resin coating layer with the first forming die and thereafter irradiating the first UV curing resin coating layer with ultraviolet radiation to cure the first UV curing resin coating layer. The step of forming the series of parallel elongated recessed surfaces includes the step of forming the series of parallel elongated recessed surfaces on the second UV curing resin coating layer with the second forming die and thereafter irradiating the second UV curing resin coating layer with ultraviolet radiation to cure the second UV curing resin coating layer.

This method enables the raised and recessed surfaces to be formed with a higher accuracy than in the case of performing merely press forming and also allows a thin light guide plate to be manufactured.

Specifically, the light guide plate manufacturing method may further include the steps of: feeding the resin sheet as an elongated continuous member horizontally in the longitudinal direction thereof; forming a first UV curing resin coating layer on the resin sheet being fed; pressing the series of parallel elongated recessed forming surfaces of the first forming die formed as a roller type against the first UV curing resin coating layer on the resin sheet being fed while rotating the first forming die to form the series of parallel elongated raised surfaces on the first UV curing resin coating layer; forming a second UV curing resin coating layer on the resin sheet being fed; and pressing the series of parallel elongated raised forming surfaces of the second forming die formed as a roller type against the second UV curing resin coating layer on the resin sheet being fed while rotating the second forming die to form the series of parallel elongated recessed surfaces on the second UV curing resin coating layer.

The method may further include the step of cutting the synthetic resin sheet having the series of parallel elongated raised and recessed surfaces formed as stated above to obtain a rectangular light guide plate having a side edge surface defined by a surface extending in a direction normal to the series of parallel elongated raised surfaces.

The above-described method enables light guide plates to be mass-produced efficiently and can also be adapted for multi-product small-lot production. Light guide plates of desired size can be manufactured by merely preparing one set of forming dies.

In addition, the present invention provides a backlight unit having the above-described light guide plate and a light source set adjacent to the light entrance plane of the light guide plate so that light from the light source enters the light guide plate through the light entrance plane. In the backlight unit, the above-described first surface is defined as a light exit surface. Because of using the light guide plate arranged as stated above, the backlight unit has minimized luminance unevenness on the light exit surface.

### BRIEF DESCRIPTION OF THE DRAWINGS

FIG. 1 is a perspective view of a light guide plate according to an embodiment of the present invention.

FIG. 2a is a diagram showing the light guide plate in FIG. 1 as seen in the direction of the arrow 2a.

FIG. 2b is a diagram showing the light guide plate in FIG. 1 as seen in the direction of the arrow 2b.

FIG. 3 is a diagram illustrating the actions of elongated raised surfaces on a first surface of the light guide plate in FIG. 1 and elongated recessed surfaces on a second surface thereof, which are available when the raised surfaces and the recessed surfaces are arranged to extend in respective directions normal to each other.

FIG. 4a is a diagram showing a section of the light guide plate in FIG. 3 in the longitudinal direction of the elongated raised surfaces on the first surface thereof to explain the action of the elongated raised surfaces.

FIG. 4b is a diagram showing the light guide plate in FIG. 4a as seen from the first surface side thereof to explain the action of the elongated raised surfaces on the first surface.

FIG. 5 is a perspective view illustrating a method of manufacturing the light guide plate shown in FIG. 1.

FIG. 6 is a side view showing the way in which press forming is performed with a combination of upper and lower press dies in the manufacturing method illustrated in FIG. 5.

FIG. 7a is a perspective view showing the die configuration of the upper press die in FIG. 5.

FIG. 7b is a perspective view showing the die configuration of the lower press die in FIG. 5.

FIG. 8 is a side view of a backlight unit provided in a liquid crystal display device according to an embodiment of the present invention.

FIG. 9 is a perspective view of a light guide plate and a light source in the backlight unit shown in FIG. 8.

FIG. 10 is a diagram illustrating the action of elongated recessed surfaces provided on a second surface of the light guide plate shown in FIG. 9.

FIG. 11 is an explanatory view illustrating a method of manufacturing the light guide plate according to the present invention by roller.

FIG. 12a is a perspective view of an upper roller shown in FIG. 11.

FIG. 12b is a perspective view of a lower roller shown in FIG. 11.

FIG. 13 is a perspective view of a light guide plate and a light source according to another embodiment of the present invention.

FIG. 14a is a diagram showing the light guide plate in FIG. 13 as seen in the direction of the arrow 14a.

FIG. 14b is a diagram showing the light guide plate in FIG. 13 as seen in the direction of the arrow 14b.

FIG. 15 is an enlarged side view of FIG. 14b, showing the angle relationship between inclined surfaces defining elongated recessed surfaces on a second surface of the light guide plate.

FIG. 16 is a diagram illustrating a method of manufacturing the light guide plate shown in FIG. 13.

FIG. 17 is a side view showing a light guide plate and a light source according to a further embodiment of the present invention.

FIG. 18 is a diagram illustrating a method of manufacturing the light guide plate shown in FIG. 17.

FIG. 19a is a plan view of a light guide plate according to a still further embodiment of the present invention.

FIG. 19b is a side view of the light guide plate shown in FIG. 19a.

FIG. 20 is a diagram illustrating a method of manufacturing the light guide plate shown in FIG. 19a.

FIG. 21 is an exploded perspective view of a liquid crystal display device having a backlight unit according to a conventional technique.

### DETAILED DESCRIPTION OF THE PREFERRED EMBODIMENTS

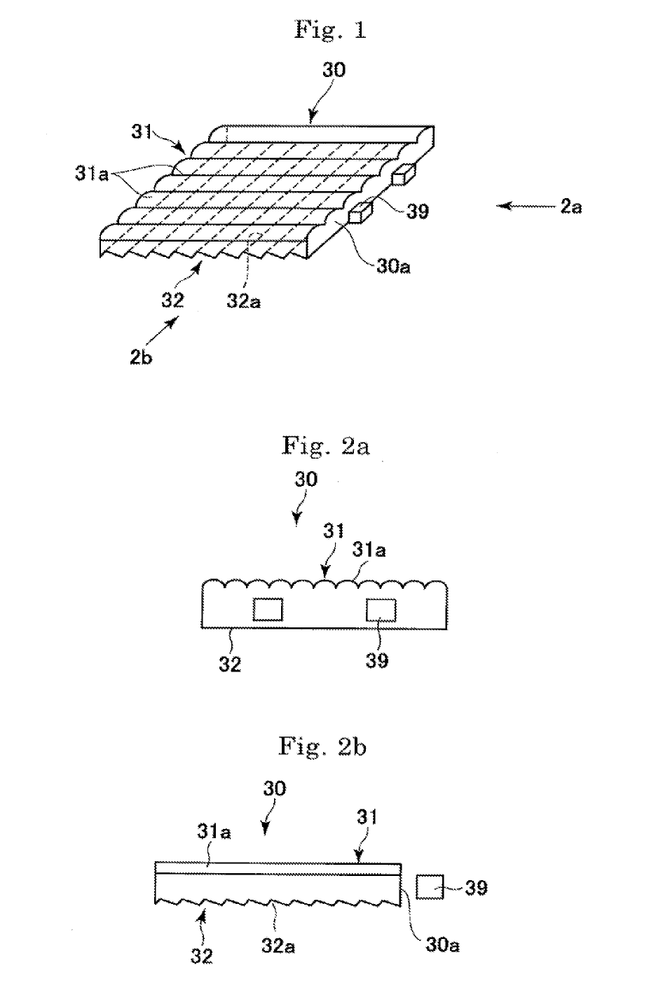

FIGS. 1 to 2b show an edge-light type rectangular light guide plate 30 according to the present invention.

The light guide plate 30 has a first surface (upper surface as viewed in the FIG. 31, a second surface (lower surface) 32 opposed to the first surface 31, and four side edge surfaces extending between the peripheral edges of the first and second surfaces 31 and 32. One of the side edge surfaces is defined as a light entrance plane 30a. The first surface 31 has a series of elongated raised surfaces 31a of arcuate cross-section extending parallel to each other. The second surface 32 has a series of elongated recessed surfaces 32a of triangular cross-section extending in a direction normal to the raised surfaces 31a on the first surface 31. The light entrance plane 30a extends in a direction normal to the elongated raised surfaces 31a. The height of the raised surfaces 31a and the depth of the recessed surfaces 32a are from several μm to several tens of μm. The pitch of the raised and recessed surfaces 31a and 32a is from several tens of μm to a hundred and several tens of μm.

A light source 39 is set at a position adjacent to the light entrance plane 30a so that light from the light source 39 enters the light guide plate 30 through the light entrance plane 30a. In the illustrated example, two LEDs (light-emitting diodes) are shown as the light source 39. The light source 39, however, may be an elongated cold-cathode tube or the like.

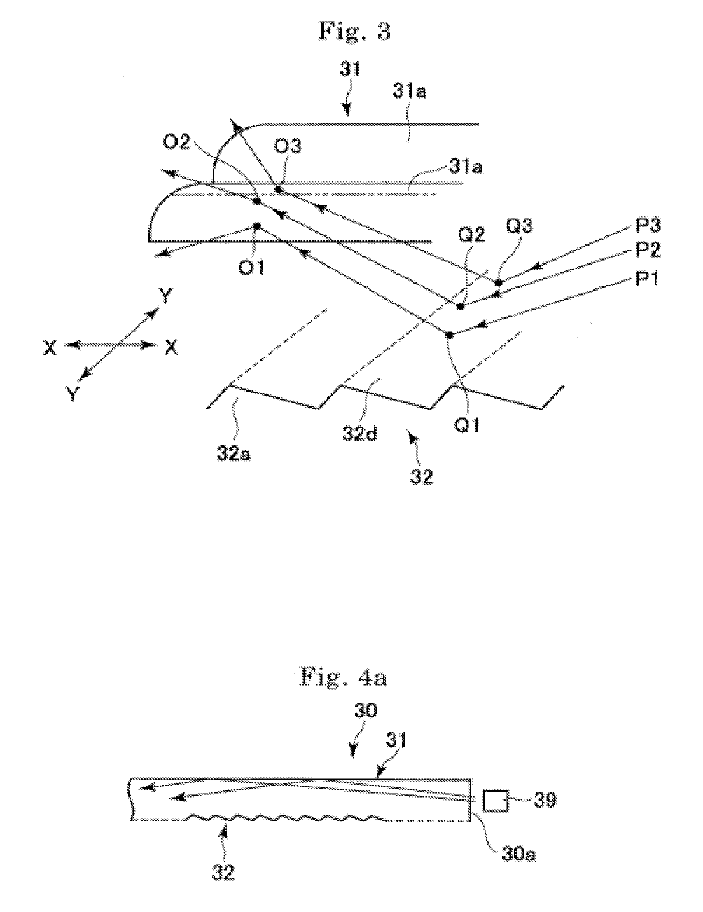

FIG. 3 shows the actions of the elongated raised surfaces 31a on the first surface 31 and the elongated recessed surfaces 32a on the second surface 32, which are available when the raised and recessed surfaces 31a and 32a are arranged to extend in respective directions normal to each other. Let us assume that, in FIG. 3, the longitudinal direction of the elongated raised surfaces 31a is an X direction, and the longitudinal direction of the elongated recessed surfaces 32a is a Y direction. It is also assumed that three mutually parallel rays P₁, P₂ and P₃ traveling in the X direction are incident at different positions Q₁, Q₂ and Q₃ on a recessed surface 32a at angles greater than the critical angle, and the reflected rays P₁, P₂ and P₃ are incident at respective positions O₁, O₂ and O₃ on a raised surface 31a on the first surface at angles not greater than the critical angle. In this regard, if the position O₂ is substantially near the ridge of the elongated raised surface 31a and the positions O₁ and O₃ are at both sides of the ridge, the ray P₂ incident at the position O₂ is refracted to change the direction of travel only slightly toward the Y direction as it exits to the outside from the elongated raised surface 31a. The rays P1 and P3 incident at the positions O₁ and O₃ are refracted to change the travel direction not only in the X direction but also in the Y direction to a considerable extent so as to diverge from each other as they exit to the outside from the elongated raised surface 31a. As will be understood from the above, if the elongated raised surfaces 31a on the first surface 31 and the elongated recessed surfaces 32a on the second surface 32 are arranged to extend in respective directions normal to each other, light entering the light guide plate is widely diffused as it exits the first surface. Thus, the uniformity of luminance distribution can be improved effectively.

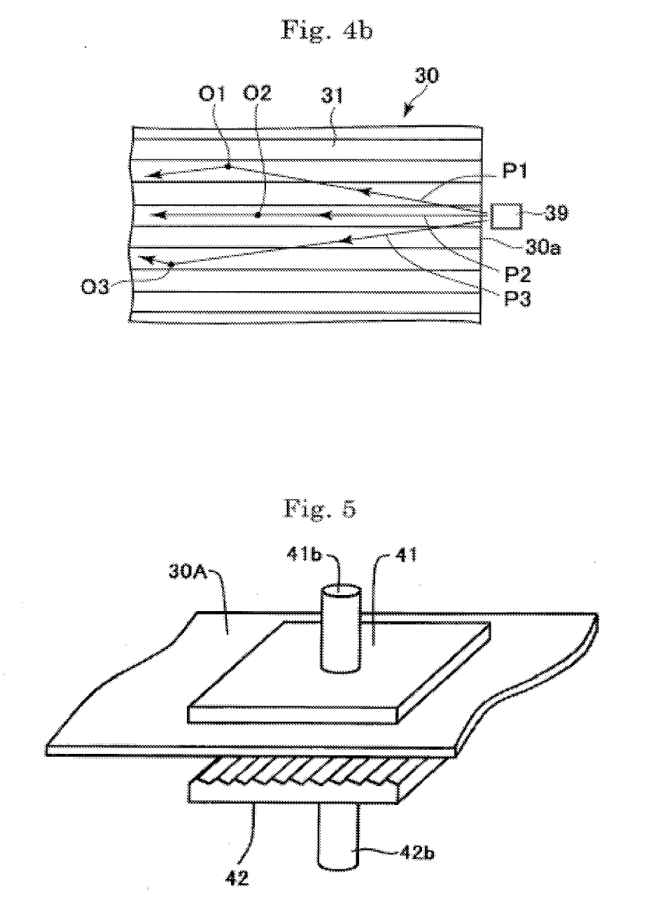

Next, the action of the elongated raised surfaces 31a on the first surface that extend at right angles to the light entrance plane 30a will be explained with reference to FIGS. 4a and 4b.

In FIG. 4a, light from the light source 39 enters the light guide plate 30 through the light entrance plane 30a. Let us assume that, of the incident light, a ray P₂ parallel to the longitudinal direction of the elongated raised surfaces 31a on the first surface as viewed in FIG. 4b and rays P₁ and P₃ that are at angles to the longitudinal direction are incident on the elongated raised surfaces 31a at respective positions O₁, O₂ and O₃. If the angle of incidence is greater than the critical angle, the rays P₁, P₂ and P₃ are all totally reflected to travel toward the inner part of the light guide plate 30. Thus, light can be guided sufficiently as far as an inner region which is away from the light entrance plane in the light guide plate 30 and which light cannot readily reach, and it is possible to increase the luminance on the first surface 31, which serves as a light exit surface and is a region corresponding to the inner region of the light guide plate 30.

As will be understood from the above, received light can be readily guided toward the inner part of the light guide plate 30 by arranging the elongated raised surfaces 31a on the first surface 31 and the elongated recessed surfaces 32a on the second surface 32 as stated above. In addition, because exiting light from the light guide plate 30 is changed in direction and a uniform luminance distribution can be attained over the light exit surface.

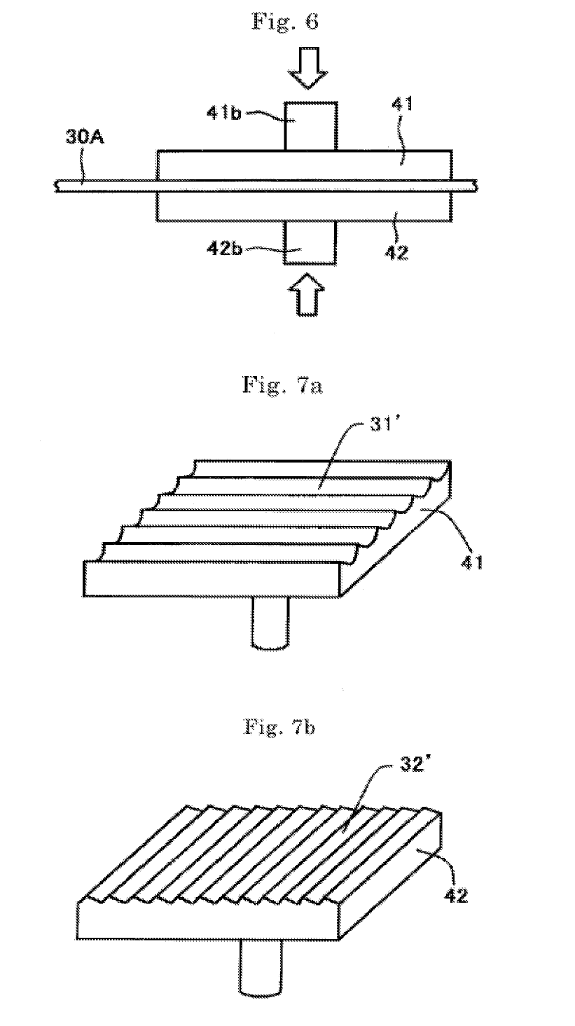

The light guide plate 30 can be formed by a hot pressing process described below with reference to FIGS. 5 to 7.

In FIG. 5, a resin sheet 30A is a material used to form a light guide plate. The resin sheet 30A may be an acrylic resin sheet, a polycarbonate resin sheet, etc.

An upper press die 41 and a lower press die 42 are set to hold the resin sheet 30A from the upper and lower sides thereof to form the above-described elongated raised surfaces 31a on the upper surface of the resin sheet 30A and the elongated recessed surfaces 32a on the lower surface thereof. More specifically, as shown in FIG. 7a, the upper press die 41 has a press surface 31′ configured to enable the above-described elongated raised surfaces 31a to be formed by pressing the press surface 31′ against the resin sheet 30A. The lower press die 42 has, as shown in FIG. 7b, a press surface 32′ configured to enable the elongated recessed surfaces 32a to be formed by pressing the press surface 32′ against the resin sheet 30A. The press surface configurations are simple and hence easy to form by using a numerically-controlled milling machine, grinding machine or the like.

The upper press die 41 and the lower press die 42 are equipped with heaters or other heating devices to press the resin sheet 30A heated to a temperature not lower than the softening point thereof. For example, the acrylic resin sheet has a softening point in the range of from 100° C. to 110° C. The polycarbonate resin sheet has a softening point in the range of from 130° C. to 140° C. Therefore, these resin sheets are heated to a temperature not lower than their softening points.

In FIG. 5, the upper press die 41 and the lower press die 42 are attached to a pressing machine (not shown) through connecting rods 41b and 42b, respectively.

In press forming operation, the upper press die 41 and the lower press die 42, which have been heated, are pressed so as to hold the resin sheet 30A from the upper and lower sides thereof. After elongated raised surfaces 31a and elongated recessed surfaces 32a have been formed, the upper press die 41 is raised, while the lower press die 42 is lowered, and the resin sheet 30A is removed from between the upper and lower press dies 41 and 42 by a stock feeder. The resin sheet 30A is larger in size than the actual light guide plate. After the elongated raised surfaces 31a and the elongated recessed surfaces 32a have been formed as stated above, the resin sheet 30A is cut into a light guide plate of desired size. Light guide plates of various sizes can be formed by merely making the upper press die 41 and the lower press die 42. Thus, the die making cost can be reduced in comparison to the conventional injection molding process.

When the above-described hot pressing process is used, the thickness of the light guide plate 30 is determined substantially by the thickness of the resin sheet 30A. Accordingly, it is possible to readily form a light guide plate of desired thickness, e.g. 0.05 to 0.3 mm, which is very thin in comparison to the conventional light guide plates.

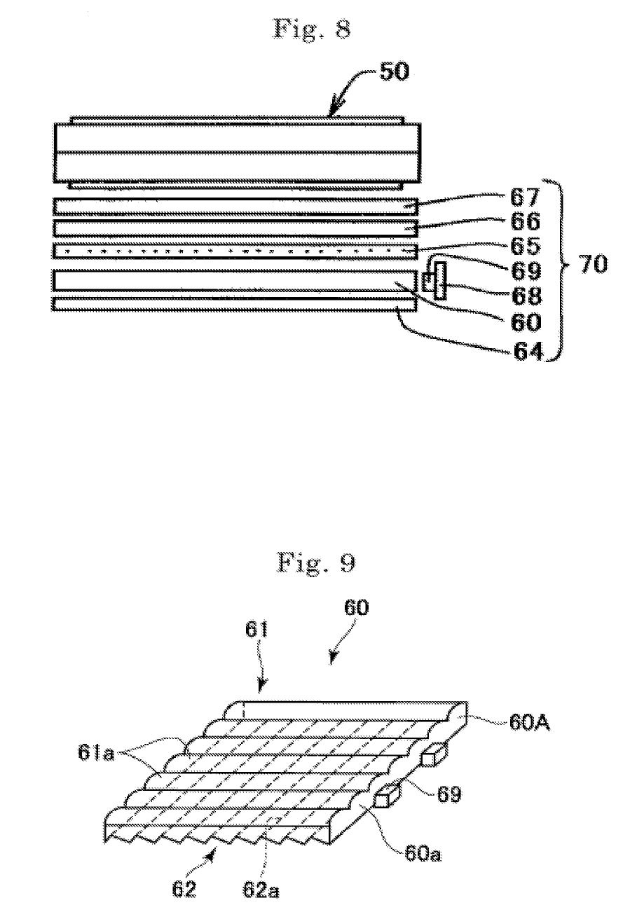

FIGS. 8 to 10 show a backlight unit 70 using the above-described light guide plate to illuminate a liquid crystal display device 50.

The backlight unit 70 is provided at the lower side of the liquid crystal display device 50 (i.e. at the side opposite to the side thereof where image display is performed). The backlight unit 70 has a reflective sheet 64, a light guide plate 60, a light diffuser sheet 65, a first prism sheet 66, and a second prism sheet 67, which are stacked in the order mentioned from the bottom thereof. The backlight unit 70 further has a light source 69 provided adjacent to the light guide plate 60. The light source 69 comprises LEDs mounted on a light source wiring board 68. Although in FIG. 8 the constituent parts of the backlight unit 70 are depicted as being stacked with a gap between each pair of adjacent parts, they may be superimposed on one another without a gap therebetween.

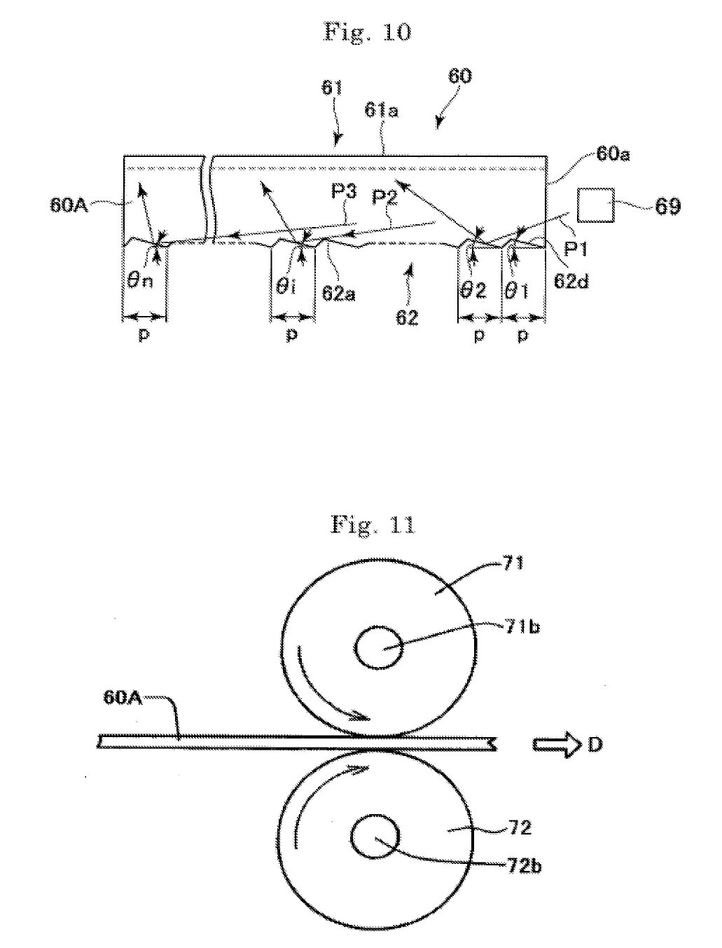

The light guide plate 60 constituting the backlight unit 70 has, as shown in FIGS. 9 and 10, a series of elongated raised surfaces 61a on a light exit surface (upper surface as viewed in FIGS. 9 and 10) 61. The elongated raised surfaces 61a are the same as the above-described elongated recessed surfaces and provided to extend in a direction normal to a light entrance plane 60a adjacent to the light source 69. On a lower surface 62 of the light guide plate 60 are provided a series of elongated recessed surfaces 62a that are the same as the above-described elongated recessed surfaces. The elongated recessed surfaces 62a extend in a direction normal to the elongated raised surfaces 61a.

The light guide plate 60 is formed from a resin sheet of polycarbonate or acrylic resin having a thickness of approximately 250 μm. The elongated raised surfaces 61a have a height of 5 to 25 μm and a pitch of 100 to 200 μm. The elongated recessed surfaces 62a have a pitch of 50 to 200 μm. Of two inclined surfaces defining each recessed surface 62a, the inclined surfaces 62d closer to the light source 69 has an inclination angle θ, (i=1, 2, . . . , n) that gradually increases with the recessed surfaces 62a being situated farther away from the light source 69 within a range of from 2° to 30°.

The farther away from the light source, the smaller the amount of light that reaches the recessed surfaces. Therefore, the inclined angles of the inclined surfaces are gradually increased with the recessed surfaces being situated farther away from the light source as stated above, whereby the light entering the light guide plate from the light source is efficiently reflected toward the light exit surface so that light is emitted even more uniformly from the entire area of the light exit surface, thereby attaining a uniform luminance distribution over the entire light exit surface.

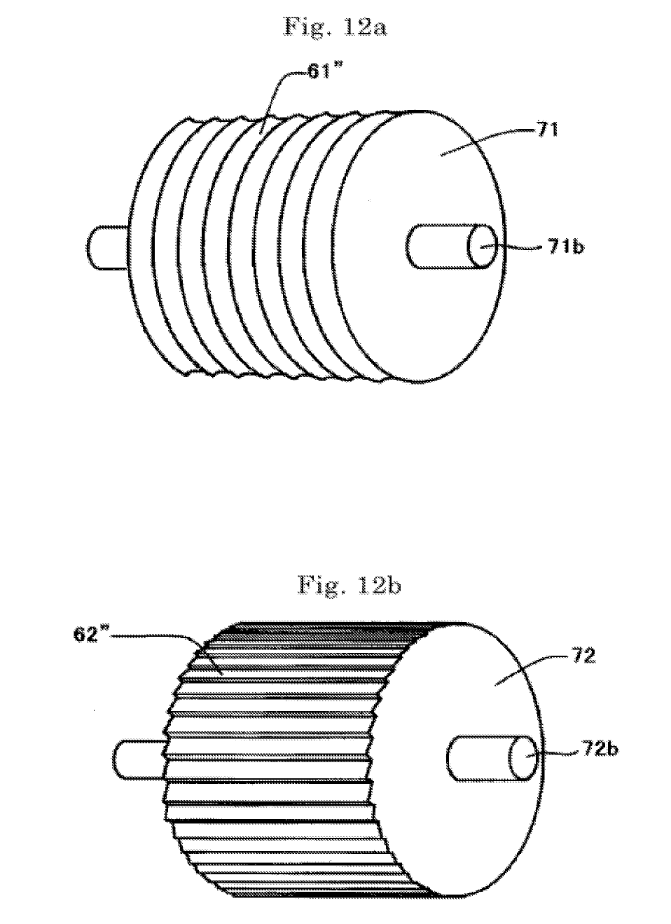

FIGS. 11 to 12b show a hot pressing process using an upper roller 71 and a lower roller 72.

The upper roller 71 has, as shown in FIG. 12a, an outer peripheral surface formed as a forming surface 61″ that enables the above-described elongated raised surfaces 61a to be formed by press-rolling the upper roller 71 on a resin sheet 60A. The lower roller 72 has, as shown in FIG. 12b, an outer peripheral surface formed as a forming surface 62″ that enables the above-described elongated recessed surfaces 62a to be formed by press-rolling the lower roller 72 on the resin sheet 60A. The upper roller 71 and the lower roller 72 are connected to a rotational drive apparatus through respective connecting shafts 71b and 72b. As shown in FIG. 11, the upper roller 71 and the lower roller 72 rotate with the resin sheet 60A held therebetween. In this way, the resin sheet 60A is conveyed in the direction indicated by the arrow D, thereby forming elongated raised surfaces 61a on the upper surface (as viewed in FIG. 11) of the resin sheet 60A and elongated recessed surfaces 62a on the lower surface thereof. Except for the above-described point, the pressing process is substantially the same as the process described above with reference to FIGS. 5 to 7b. Therefore, a detailed description thereof is omitted herein.

The reflective sheet 64 may be formed from a resin sheet provided with a metal film of high light reflectance. For example, the reflective sheet 64 may be formed from a PET (polyethylene terephthalate) sheet provided with an aluminum metal evaporated film. The reflective sheet 64 may be formed with a thickness in the range of from 70 to 120 μm.

The light diffuser sheet 65 may be formed from a transparent resin, such as an acrylic or polycarbonate resin, having silica particles dispersed therein. The light diffuser sheet 65 may be formed with a thickness in the range of from 50 to 100 μm. The light diffuser sheet 65 is provided for the purpose of further diffusing light exiting the light guide plate 60 to achieve a uniform luminance distribution.

The first prism sheet 66 and the second prism sheet 67 are prism sheets of the same configuration. The first and second prism sheets 66 and 67 are arranged with their respective ridges extending perpendicular to each other to increase the lighting intensity. Both the prism sheets 66 and 67 are formed by using sheets having a thickness of 50 to 300 μm.

The light source 69 is formed by using LEDs. A necessary number of LEDs are disposed close to the light entrance plane 60a of the light guide plate 60. The light source 69 comprising LEDs is mounted on a light source wiring board 68, which is a flexible printed circuit board (FPC). It should be noted that the light source 69 is not necessarily limited to LEDs.

With the above-described arrangement, the backlight unit 70 can be formed in a very thin structure having a thickness of 0.6 to 0.8 mm, which is close to a half of the thickness of the conventional backlight units, and yet provides a favorably uniform luminance distribution. That is, the uniformity of luminance on the light exit surface for illuminating the displayed image on the liquid crystal display device is substantially equal to that of the conventional backlight units.

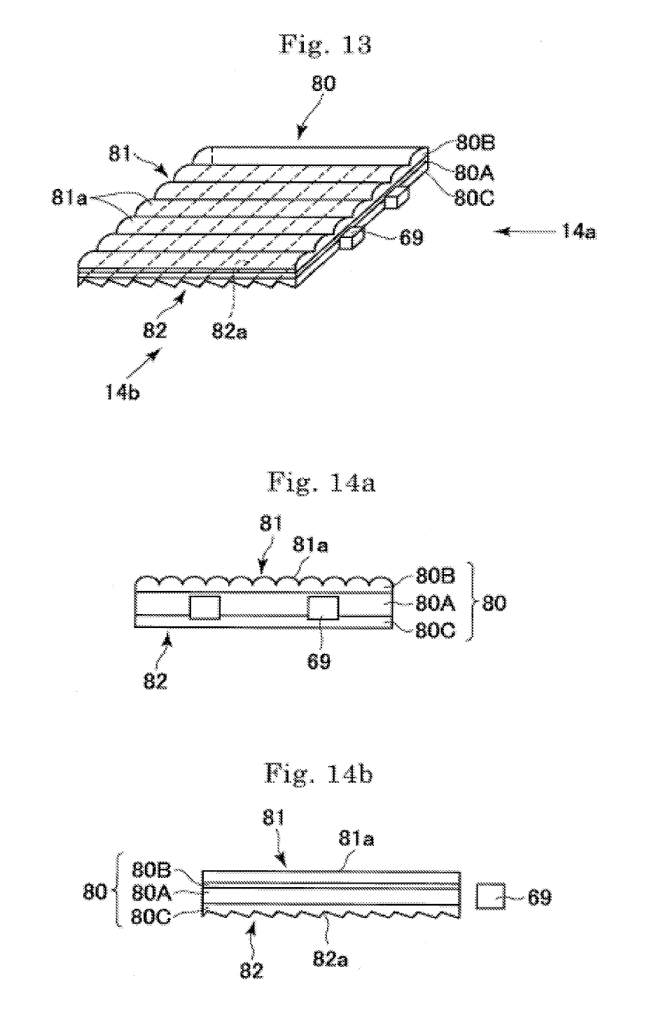

FIGS. 13 to 15 show a light guide plate 80 different in structure from the above-described light guide plate 60.

The light guide plate 80 has, as shown in FIG. 13, a series of elongated raised surfaces 81a provided on an upper surface 81 thereof to extend at right angles to a light entrance plane. On a lower surface 82 of the light guide plate 80 are provided a series of elongated recessed surfaces 82a that extend in a direction normal to the raised surfaces 81a.

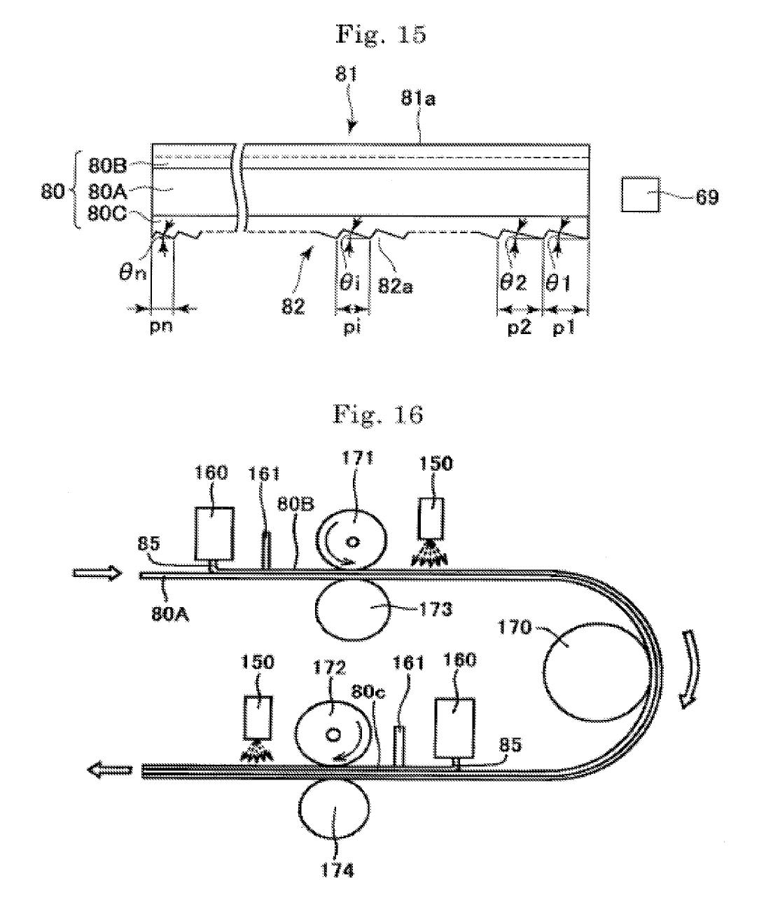

The recessed surfaces 82a have, as shown in FIG. 15, an inclination angle θᵢ (i=1, 2, . . . , n) that gradually increases with the recessed surfaces 82a being situated farther away from the light source 69. The depths of the valleys of the recessed surfaces 82a are uniform. Consequently, the pitch “p,” of the recessed surfaces 82a gradually decrease with the recessed surfaces 82a being situated farther away from the light source 69. This structure improves the uniformity of luminance over the entire light exit surface.

Specifically, the light guide plate 80 is, as shown in FIGS. 14a and 14b, formed in a three-layer structure having a resin sheet 80A, a first coating layer 80B provided on the upper surface of the resin sheet 80A, and a second coating layer 80C provided on the lower surface of the resin sheet 80A. The first coating layer 80B is formed with a series of elongated raised surfaces 81a, and the second coating layer 80C is formed with a series of elongated recessed surfaces 82a. The first coating layer 80B and the second coating layer 80C are formed from UV (ultraviolet) curing resin coatings applied to the upper and lower surfaces of the resin sheet 80A. The first coating layer 80B is formed with a series of elongated raised surfaces 81a by roller and then irradiated with ultraviolet radiation to cure the UV curing resin material. Similarly, the second coating layer 80C is formed with a series of elongated recessed surfaces 82a by roller and then irradiated with ultraviolet radiation to cure the UV curing resin material.

Examples of usable UV curing resin materials are acrylic, epoxy, urethane, urethane acrylate and epoxy acrylate resins. Materials favorably usable for the resin sheet 80A are an acrylic resin, a polycarbonate resin, etc.

The light guide plate 80 is formed through the following steps.

First, the resin sheet 80A is fed in the direction indicated by the arrow in FIG. 16. The resin sheet 80A is coated with a UV curing resin 85 by a coating applicator 160. The applied UV curing resin 85 is formed into a coating layer 80B of predetermined thickness by a blade 161. The blade 161 may be a plate or a very fine mesh net, for example. The resin sheet 80A having the coating layer 80B is then passed between a roller 171 and a support roller 173. The roller 171 is of the same specifications as those of the upper roller 71, which has been explained in connection with FIG. 12a. Consequently, a series of elongated raised surfaces 81a are formed on the coating layer 80B. Next, the resin sheet 80A is passed under an ultraviolet irradiator 150 using high-pressure mercury UV lamp, whereby the UV curing resin is cured. Next, the resin sheet 80A is turned over by a roller 170 and then coated with a UV curing resin 85 by another coating applicator 160. The applied UV curing resin 85 is formed into a coating layer 80C of predetermined thickness by a blade 161. Further, the resin sheet 80A is passed between a second roller 172 and a support roller 174. The second roller 172 is of the same specifications as those of the lower roller 72, which has been explained in connection with FIG. 12b. Consequently, a series of elongated recessed surfaces 82a are formed on the coating layer 80C. Next, the resin sheet 80A is passed under another ultraviolet irradiator 150, whereby the UV curing resin is cured.

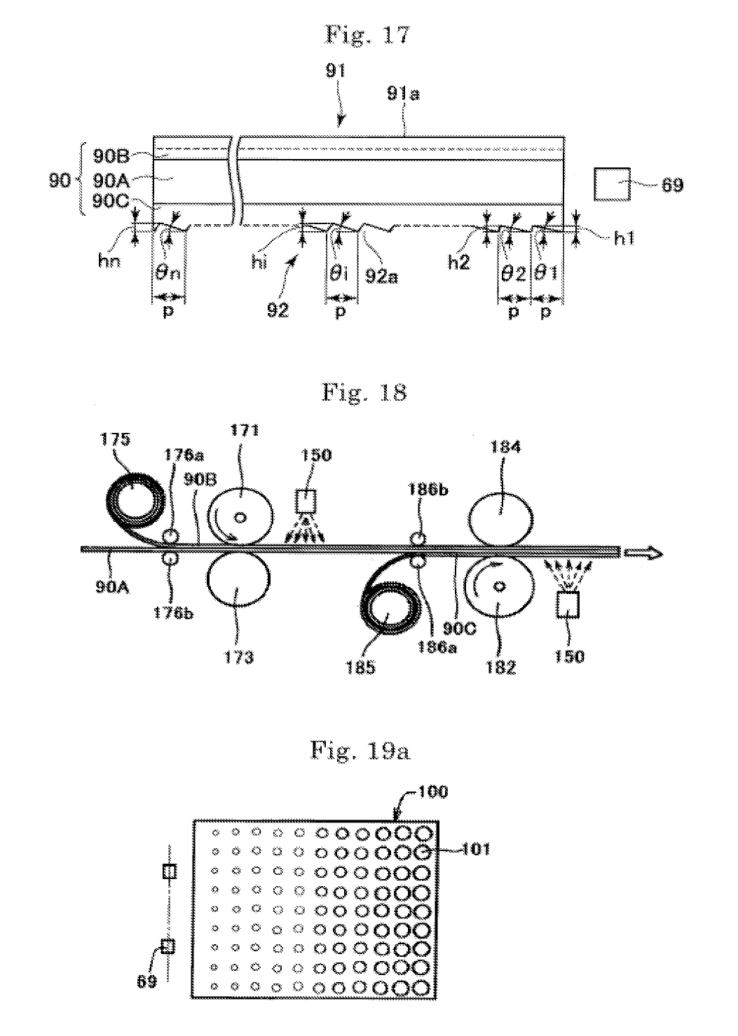

FIG. 17 shows a light guide plate 90 according to a further embodiment of the present invention. The light guide plate 90 has a series of elongated raised surfaces 91a provided on an upper surface 91 thereof to extend at right angles to a light entrance plane. On a lower surface 92 of the light guide plate 90 are provided a series of elongated recessed surfaces 92a that extend in a direction normal to the raised surfaces 91a.

The recessed surfaces 92a have an inclination angle θᵢ (i=1, 2, . . . , n) that gradually increases with the recessed surfaces 92a being situated farther away from the light source 69. The depth hᵢ of the valleys of the recessed surfaces 92a gradually increases with the recessed surfaces 92a being situated farther away from the light source 69. This structure improves the uniformity of luminance over the entire light exit surface.

FIG. 18 shows a method of forming the light guide plate 90.

According to this method, first, a resin sheet 90A and a first coating layer 90B are stuck to each other. That is, the resin sheet 90A being fed and the first coating layer 90B being fed from a roller 175 are pressure-welded together between revolving rollers 176a and 176b. Next, the resin sheet 90A is passed between a first roller 171 and a support roller 173. The first roller 171 is pressed against the first coating layer 90B while rotating it, thereby forming a series of elongated raised surfaces 91a on the first coating layer 90B. Further, the series of elongated raised surfaces 91a thus formed are irradiated with ultraviolet radiation by an ultraviolet irradiator 150 so as to be cured.

Next, a second coating layer 90C is fed to the resin sheet 90A from a roller 185 of the second coating layer 90C, and a series of elongated recessed surfaces 92a are formed on the second coating layer 90C by using rollers 186a and 186b, a combination of a lower roller 182 and a support roller 184, and an ultraviolet irradiator 150 in the same way as in the case of the first coating layer 90B.

Although rollers are used to form series of elongated raised and recessed surfaces in this embodiment, press dies are also usable to form these surfaces.

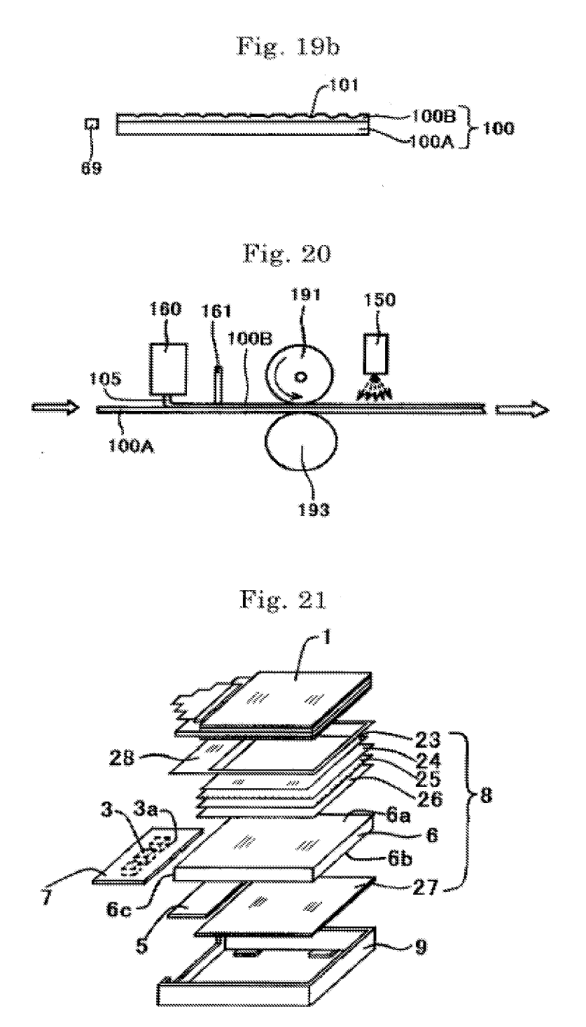

FIGS. 19a and 19b are plan and sectional views, respectively, of a light guide plate according to a still further embodiment of the present invention.

The light guide plate 100 is formed from an optical sheet comprising a base resin sheet 100A and a coating layer 100B of a UV curing resin provided thereon. The coating layer 100B is provided thereon with a multiplicity of reflecting surfaces 101 each comprising a spherical recess. The reflecting surfaces 101, which are spherical recesses, are arranged in a multiplicity of rows. In each row, the reflecting surfaces 101 gradually increase in size with the reflecting surfaces 101 being situated farther away from a light source 69 comprising LEDs.

The reflecting surfaces 101 are formed as follows. A coating layer 100B is formed from a UV curing resin, and a roller provided with spherical projections is pressed against the coating layer 100B while rotating it. Thereafter, the coating layer 100B is irradiated with ultraviolet radiation so as to be cured. This method enables formation of a thin light guide plate 100.

The light guide plate 100 is installed such that the side thereof where the reflecting surfaces 101 are provided (i.e. the upper surface) is directed toward a liquid crystal display device, thereby constituting a backlight unit. Light entering the light guide plate 100 from the light source 69 is reflected toward the lower surface by the reflecting surfaces 101. Further, the light is reflected toward the upper surface by a reflective sheet provided in contact with the lower surface and thus exits toward the liquid crystal display device. Because the reflecting surfaces 101 are spherical recesses, light reflected therefrom has no specific directivity. In addition, light reflected from the reflective sheet passes through the reflecting surfaces 101 as it exits to the outside. Therefore, exiting light is diffused. Accordingly, it is possible to obtain high uniformity of luminance over the entire area of the light exit surface.

Further, the reflecting surfaces 101 gradually increase in size with the reflecting surfaces 101 being situated farther away from the light source 69. Therefore, it is possible to increase the amount of reflected light from the reflecting surfaces 101 with distance from the light source 69. It should be noted that the reflecting surfaces 101 comprising spherical recesses may be varied in density or the depth of the recesses instead of varying the size thereof. That is, the same advantageous effect as the above can be obtained by increasing the density or depth of the recesses with the reflecting surfaces 101 being situated farther away from the light source 69.

It is also possible to obtain the same advantageous effect by placing the light guide plate 100 in such a manner that the side of the light guide plate 100 opposite to the side thereof where the reflecting surfaces 101 are provided faces the liquid crystal display device. The spherical recesses may be replaced with spherical projections (convexities). The reflecting surfaces 101 comprising spherical projections (convexities) can also offer the same advantageous effect as the above.

It is also possible to use as the reflecting surfaces 101a series of elongated recessed surfaces of triangular cross-section in the foregoing embodiments. Such elongated recessed surfaces are easy to produce, and it is easy to adjust the direction of reflection and the amount of reflected light.

Although in this embodiment reflecting surfaces are provided on only one side of the light guide plate, it is also possible to provide a diffuser on the opposite side of the light guide plate. The diffuser may comprise a series of elongated raised surfaces of circular cross-section or spherical recesses or projections formed in dots. These have both reflecting and diffusing functions.

The light guide plate 100 can be formed as follows.

First, a resin sheet 100A is fed in the direction indicated by the arrow in FIG. 20. The resin sheet 100A is coated with a UV curing resin 105 by a coating applicator 160. The applied UV curing resin 105 is formed into a coating layer 100B of predetermined thickness by a blade 161. The resin sheet 100A having the coating layer 100B is then passed between a roller 191 and a support roller 193 to form on the coating layer 100B a multiplicity of reflecting surfaces comprising spherical recesses. Next, the resin sheet 100A is passed under an ultraviolet irradiator 150 using high-pressure mercury UV lamp, whereby the UV curing resin is cured. The belt-shaped sheet formed in this way is cut into a predetermined size to obtain a light guide plate 100. This manufacturing method requires a small number of steps and enables the light guide plate 100 to be manufactured in a continuous process. Therefore, the light guide plate 100 can be produced at a low manufacturing cost.

1. A light guide plate manufacturing method comprising steps of:
preparing a resin sheet having a first surface and a second surface that are opposite to each other;
preparing a first ultraviolet curing resin coating layer and pressing the first ultraviolet curing resin coating layer against the first surface of the resin sheet to weld the first ultraviolet curing resin coating layer on the first surface of the resin sheet;
forming a series of parallel elongated raised surfaces of arcuate cross-section on the first ultraviolet curing resin coating layer;
irradiating the series of parallel elongated raised surfaces formed on the first ultraviolet curing resin coating layer with ultraviolet light to cure the series of elongated raised surfaces;
preparing a second ultraviolet curing resin coating layer and pressing the second ultraviolet curing resin coating layer against the second surface of the resin sheet to weld the second ultraviolet curing resin coating layer on the second surface of the resin sheet;
forming a series of parallel elongated recessed surfaces of triangular cross-section on the second ultraviolet curing resin coating layer to be elongated in a direction perpendicular to the parallel elongated raised surfaces of arcuate cross-section on the first ultraviolet curing resin coating layer; and
irradiating the series of parallel elongated recessed surfaces formed on the second ultraviolet curing resin coating layer with ultraviolet light to cure the series of parallel elongated recessed surfaces.

2. The light guide plate manufacturing method of claim 1, wherein the step of forming the series of parallel elongated raised surfaces of arcuate cross-section on the first ultraviolet curing resin coating layer further comprises steps of
preparing a first forming die having a series of parallel elongated recessed surfaces of arcuate cross-section;
heating the first forming die; and
pressing the series of pallarel elongated recessed surfaces of arcuate cross-section of the heated first forming die against the first ultraviolet curing resin coating layer;
further wherein the step of forming the series of parallel elongated recessed surfaces of triangular cross-section on the second ultraviolet curing resin coating layer further comprises steps of:
preparing a second forming die having a series of parallel elongated raised surfaces of triangular cross-section;
heating the second forming die; and
pressing the series of pallarel elongated raised surfaces of triangular cross-section of the heated second forming die against the second ultraviolet curing resin coating layer.

3. The light guide plate manufacturing method of claim 2, wherein the heated first forming die and the heated second forming die are pressed against the first ultraviolet curing resin coating layer and the second ultraviolet curing resin layer respectively and simultaneously to form the raised surfaces of arcuate cross-section on the first ultraviolet curing resin coating layer and the recessed surfaces of triangular cross-section on the second ultraviolet curing resin coating layer.

4. The light guide plate manufacturing method of claim 2, wherein each of the first forming die and the second forming die is in the shape of a roller, and the first forming die and the second forming die are pressed against the first ultraviolet curing resin coating layer and the second ultraviolet curing resin layer respectively and simultaneously to form the raised surfaces on the first ultraviolet curing resin coating layer and the recessed surfaces of triangular cross-section on the second ultraviolet curing resin coating layer while rotating the first forming die and the second forming die.

5. The light guide plate manufacturing method of claim 4, wherein the step of preparing the resin sheet comprises feeding the resin sheet as an elongated continuous member in a longitudinal direction of the resin sheet, the step of preparing the first ultraviolet curing resin coating layer comprises feeding the first ultraviolet curing resin coating layer on the first surface of the resin sheet as an elongated continuous member in the longitudinal direction of the resin sheet, and the step of preparing the second ultraviolet curing resin coating layer comprises feeding the second ultraviolet curing resin coating layer on the second surface of the resin sheet as an elongated continuous member in the longitudinal direction of the resin sheet.

6. The light guide plate manufacturing method of claim 5, further comprising a step of:
cutting the resin sheet having the series of parallel elongated raised surfaces of arcuate cross-section formed on the first surface of the resin sheet and the series of parallel elongated recessed surfaces of rectangular cross-section on the second surface of the resin sheet as the continuous elongated member to obtain a plurality of rectangular light guide plates.
